(19) United States
(12) Patent Application Publication
(10) Pub. No.: US 2024/0041695 A1
(43) Pub. Date: Feb. 8, 2024

(54) RELAXATION AND HEALTHCARE SOFA

(71) Applicant: GENOVA INC, DIAMOND BAR, CA (US)

(72) Inventor: Peng WU, Shanghai (CN)

(73) Assignee: GENOVA INC, DIAMOND BAR, CA (US)

(21) Appl. No.: 18/079,909

(22) Filed: Dec. 13, 2022

(30) Foreign Application Priority Data
Jul. 27, 2022 (CN) 202221959892.4

(51) Int. Cl. A61H 23/02

(52) U.S. Cl. CPC A61H 23/02; A61H 2201/0149; A61H 2201/0188; A61H 2201/0207; A61H 2201/5007; A61H 2230/30; A61H 2230/70; A61H 2201/5071

(57) ABSTRACT

A relaxation and healthcare sofa includes a sofa seat cushion. The sofa seat cushion is provided with a sofa backrest, a first sofa armrest, a second sofa armrest, a sofa base, and a control motherboard. Each of the first and second sofa armrests is provided with a first placement slot, and a first massage airbag and a body fat detection electrode are arranged in the first placement slot. The first sofa armrest is provided with a second placement slot, and a blood pressure detection device and a detection cuff are arranged in the second placement slot. An inflatable component is arranged in the sofa seat cushion, and the inflatable component is in communication with the first massage airbag and the detection cuff. The sofa base is provided with a pressure sensor. The body fat detection electrode, the inflatable component, and the pressure sensor are electrically connected to the control motherboard.

### CROSS REFERENCE TO THE RELATED APPLICATIONS

This application is based upon and claims priority to Chinese Patent Application No. 202221959892.4, filed on Jul. 27, 2022, the entire contents of which are incorporated herein by reference.

### TECHNICAL FIELD

The present disclosure relates to the technical field of healthcare equipment, particularly to a relaxation and healthcare sofa.

### BACKGROUND

A sofa is a piece of soft furniture that has armrests on both sides and can be a single-seat or multi-seat chair with a soft cushion, for example, a chair with a backrest made of spring or thick foam plastic. The sofa is becoming an essential piece of furniture in many families. A comfortable sofa is indispensable to the living room. Sitting on a comfortable sofa after work can relax a person's body and mind.

With the improvement in the quality of life, massage sofas gradually appeared. When people sit on the sofa to rest, the massage sofa can massage the human body to improve comfort. As people are becoming more concerned about their health, measuring weight and monitoring the physiological parameters of the human body have become important. However, the sofas in the prior art can only provide people with rest but are unable to measure the weight and monitor the physiological parameters of the human body.

The patent with a public number of CN113545622A discloses a massage sofa. The massage sofa is provided with a protuberant neck airbag near the human neck, and the neck airbag is a multilayer airbag. When the air pump inflates the neck airbag with the gradual increase of the gas in the neck airbag, the neck airbag turns toward the human neck into an upright state under the action of the gas and partially covers the human neck to massage the human neck. However, this patent still has the defect that it can only provide rest and massage and cannot carry out health tests.

### SUMMARY

In view of the defects in the prior art, an objective of the present disclosure is to provide a relaxation and healthcare sofa.

The relaxation and healthcare sofa provided according to the present disclosure includes a sofa seat cushion. The sofa seat cushion is provided with a sofa backrest, a first sofa armrest, a second sofa armrest, a sofa base, and a control motherboard.

Each of the first sofa armrest and the second sofa armrest is provided with a first placement slot, and a first massage airbag and a body fat detection electrode are arranged in the first placement slot. The first sofa armrest is provided with a second placement slot, and a blood pressure detection device and a detection cuff are arranged in the second placement slot.

An inflatable component is arranged in the sofa seat cushion and is in communication with the first massage airbag and the detection cuff. The sofa base is provided with a pressure sensor.

The body fat detection electrode, the inflatable component, and the pressure sensor are electrically connected to the control motherboard.

Preferably, the sofa backrest is arranged on a side wall of the sofa seat cushion.

The first sofa armrest and the second sofa armrest are located on both sides of the sofa seat cushion, respectively.

The sofa base is arranged on the bottom side wall of the sofa seat cushion.

Preferably, a heating device is arranged on the sofa backrest, and the heating device is electrically connected to the control motherboard.

Preferably, a ventilation device is arranged on the sofa backrest, and the ventilation device is electrically connected to the control motherboard.

Preferably, a speaker component is arranged on the sofa backrest, and the speaker component is electrically connected to the control motherboard.

The speaker component is arranged at the positions corresponding to the user's ears on the sofa backrest.

Preferably, each of the peripheral edge of the first sofa armrest and the peripheral edge of the second sofa armrest is provided with a light emitting diode (LED) light strip component, and the LED light strip component is electrically connected to the control motherboard.

Preferably, each of a side wall of the first sofa armrest and a side wall of the second sofa armrest is provided with a storage bag for placing items.

Preferably, a cover pad is arranged at an opening of the second placement slot, and the cover pad is detachably arranged on the first sofa armrest.

Preferably, a massage component is arranged on the sofa seat cushion and the sofa backrest.

Preferably, the sofa base is configured as a rectangular support base. A single pressure sensor is arranged, and the single pressure sensor is entirely arranged below the rectangular support base.

Preferably, the sofa base is provided with a lifting component, and the lifting component is electrically connected to the control motherboard. The lifting component is configured to raise or lower the sofa seat cushion.

Preferably, the first sofa armrest is provided with a wireless fidelity (WI-FI) chip and a control wire, and the WI-FI chip and the control wire are electrically connected to the control motherboard.

Preferably, the health parameters detected by the body fat detection electrode include muscle storage capacity level, protein, basal metabolic rate, water content, body weight, fat rate, body mass index (BMI), muscle mass, bone mass, body age, visceral fat index, and resting heart rate.

The health parameter detected by the blood pressure detection device includes blood pressure.

Preferably, a support clamping component is arranged on the first sofa armrest, and the support clamping component is configured to clamp a mobile phone or a tablet.

Preferably, the second sofa armrest is provided with a universal serial bus (USB) charging port.

Preferably, a microphone component is arranged in the second sofa armrest.

Compared with the prior art, the present disclosure has the following advantages:
1. According to the present disclosure, the health condition of the human body can be detected while providing rest and massage and has high practicability.
2. According to the present disclosure, the user is enabled to complete the health detection work when resting on the sofa, and the health detection results can be displayed on the display operation panel for easy viewing.
3. According to the present disclosure, by arranging the first placing slot, it is convenient for the user to place the arms in the accurate positions and hold the body fat detection electrode by hand to facilitate the detection of the user and realize the accurate detection. By arranging the second placing slot, it is convenient for the user to place the blood pressure detection device and the detection cuff on their body, such that it is convenient to detect the health condition of the user through the blood pressure detection device and the detection cuff and improve the convenience.

### BRIEF DESCRIPTION OF THE DRAWINGS

Other features, objectives, and advantages of the present disclosure will become more apparent by reading the detailed description of the non-restrictive embodiments with reference to the drawings below:

FIG. 1 is a schematic diagram of the overall structure of the relaxation and healthcare sofa of the present disclosure.

FIG. 2 is a schematic diagram of the structure to highlight a cover pad of the relaxation and healthcare sofa of the present disclosure.

FIG. 3 is a schematic diagram of the structure to highlight a massage component of the relaxation and healthcare sofa of the present disclosure.

FIG. 4 is a schematic diagram of the structure to highlight a heating device for the relaxation and healthcare sofa of the present disclosure.

FIG. 5 is a schematic diagram of the structure to highlight a ventilation device for the relaxation and healthcare sofa of the present disclosure.

FIG. 6 is a schematic diagram of the structure to highlight a lifting component of the relaxation and healthcare sofa of the present disclosure.

FIG. 7 is a schematic diagram of the structure to highlight a support clamping component of the relaxation and healthcare sofa of the present disclosure.

In the FIGURES:

| | |
|---|---|
| sofa seat cushion 1 | ventilation device 13 |
| sofa backrest 2 | speaker component 14 |
| first sofa armrest 3 | LED light strip component 15 |
| second sofa armrest 4 | storage bag 16 |
| sofa base 5 | cover pad 17 |
| first placement slot 6 | massage component 18 |
| first massage airbag 7 | lifting component 19 |
| body fat detection electrode 8 | power plug 20 |
| second placement slot 9 | support clamping component 21 |
| blood pressure detection device 10 | detection cuff 22 |
| pressure sensor 11 | USB charging port 23 |
| heating device 12 | |

### DETAILED DESCRIPTION OF THE EMBODIMENTS

The present disclosure is described in detail below in combination with specific embodiments. The following embodiments will help those skilled in the art to further understand the present disclosure but shall not limit the present disclosure in any form. It should be noted that for those having ordinary skills in the art, a number of changes and improvements can be made without departing from the concept of the present disclosure. All these improvements should be within the scope of protection of the present disclosure.

### Embodiment 1

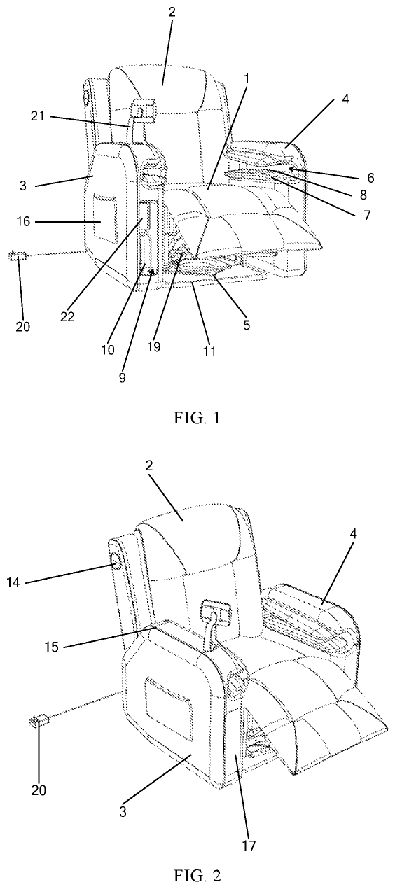

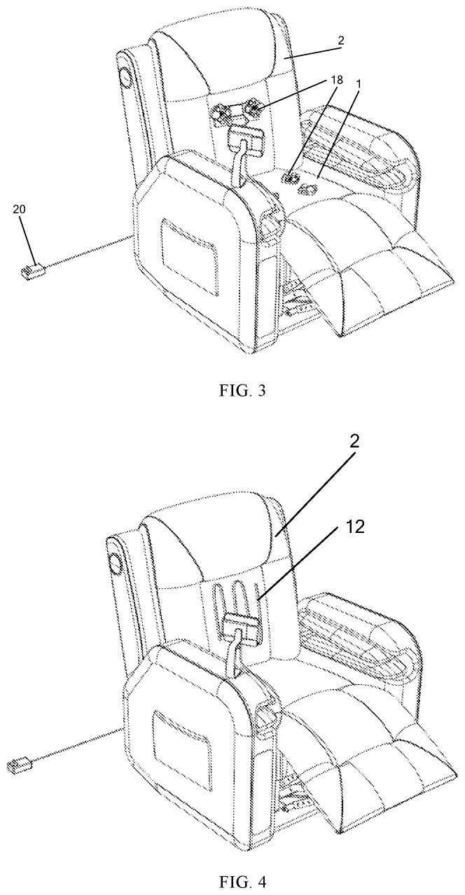

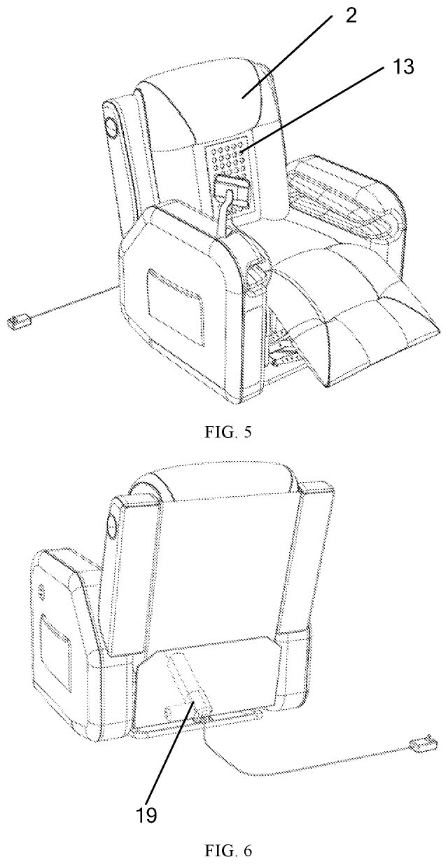

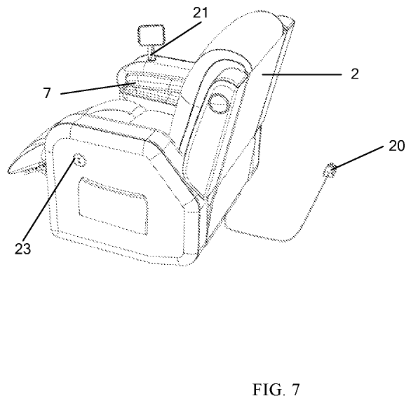

As shown in FIGS. 1-7, according to the embodiment, a relaxation and healthcare sofa includes the sofa seat cushion 1. The sofa seat cushion 1 is provided with the sofa backrest 2, the first sofa armrest 3, the second sofa armrest 4, the sofa base 5, and the control motherboard. The sofa backrest 2 is arranged on a side wall of the sofa seat cushion 1. The first sofa armrest 3 and the second sofa armrest 4 are located on both sides of the sofa seat cushion 1, respectively. The sofa base 5 is arranged on the bottom side wall of the sofa seat cushion 1. The sofa base 5 is configured as a rectangular support base. A single pressure sensor 11 is arranged, and the single pressure sensor 11 is entirely arranged below the rectangular support base. A weighing device is entirely located below the sofa base 5, which makes the value measured by the weighing device more stable.

Each of the first sofa armrest 3 and the second sofa armrest 4 is provided with the first placement slot 6, and the first massage airbag 7 and the body fat detection electrode 8 are arranged in the first placement slot 6. The first sofa armrest 3 is provided with the second placement slot 9, and the blood pressure detection device 10 and the detection cuff 22 are arranged in the second placement slot 9. The inflatable component is arranged in the sofa seat cushion 1, and the inflatable component is in communication with the first massage airbag 7 and the detection cuff 22. The sofa base 5 is provided with the pressure sensor 11. The body fat detection electrode 8, the inflatable component, and the pressure sensor 11 are electrically connected to the control motherboard. In the usual design, the inflatable component adopts a blower, while the body fat detection electrode 8 adopts a conductive iron sheet, and the control motherboard adopts a control chip.

The cover pad 17 is arranged at an opening of the second placement slot 9, and the cover pad 17 is detachably arranged on the first sofa armrest 3. In the usual design, the cover pad 17 is detachably arranged on the first sofa armrest 3 by hook and loop fasteners. The detaching and installing of the cover pad 17 on the first sofa armrest 3 are convenient for taking and storing the detection cuff 22, thereby facilitating a blood pressure test.

The health parameters detected by the body fat detection electrode 8 include muscle storage capacity level, protein, basal metabolic rate, water content, body weight, fat rate, BMI, muscle mass, bone mass, body age, visceral fat index, and resting heart rate. The health parameter detected by the blood pressure detection device 10 includes blood pressure.

The heating device 12 is arranged on the sofa backrest 2, and the heating device 12 is electrically connected to the control motherboard. The ventilation device 13 is arranged on the sofa backrest 2 and is electrically connected to the control motherboard. The heating device 12 includes an electric heating wire and a heat conducting plate, both of which are powered on to heat the sofa to realize the heating function of the sofa. The ventilation device 13 includes the blower, the air outlet, and the perforated leather which are located at the position of the sofa backrest. The ventilation function is realized through the cooperation of the blower, the air outlet, and the perforated leather.

The massage component 18 is arranged on the sofa seat cushion 1 and the sofa backrest 2. In the usual design, the massage component 18 is a vibration massager. The vibration component can be arranged at the positions of the head, waist, legs, and back and is configured to give a massage to make users more comfortable when they lie down.

The speaker component 14 is arranged on the sofa backrest 2, and the speaker component 14 is electrically connected to the control motherboard. The speaker component 14 is arranged at the positions corresponding to the user's ears on the sofa backrest 2. In the usual design, the speaker component 14 is a speaker, and the speaker is located outside the ear position of the sofa, which has a better sound.

Each of the peripheral edge of the first sofa armrest 3 and the peripheral edge of the second sofa armrest 4 is provided with an LED light strip component 15, and the LED light strip component 15 is electrically connected to the control motherboard. In the usual design, the LED light strip component 15 adopts an LED light strip.

Each of a side wall of the first sofa armrest 3 and a side wall of the second sofa armrest 4 is provided with the storage bag 16 for placing items. During use, it is convenient for the user to place the carry-on items.

The sofa base 5 is provided with the lifting component 19, and the lifting component 19 is electrically connected to the control motherboard. The lifting component 19 is configured to raise or lower the sofa seat cushion 1. The lifting component 19 adopts a driving cylinder and a driving frame to realize the raising and lowering of the sofa seat cushion where the legs are placed, thereby facilitating the elderly or people with limited mobility to get off the sofa. The lifting manner is not only to vertically raise or lower the seat cushion but also to tilt the front and rear angles of the seat cushion, which is convenient for the elderly with limited mobility to get on or off the sofa. For example, when an elderly person wants to get off the sofa but has difficulty moving, the inclination angle of the sofa cushion can be adjusted, so that the rear part of the sofa seat cushion is raised, and the front part is lowered. In this way, the elderly on the sofa is easily changed from the sitting posture to the standing posture, which assists the function of getting on or off the sofa.

A support clamping component is arranged on the first sofa armrest, and the support clamping component is configured to clamp a mobile phone or a tablet. In the usual design, the support clamping component adopts a support clamping frame, which is convenient for clamping the mobile terminal, such as a mobile phone or a tablet, and connecting the mobile terminal to the control component of the sofa to facilitate the operation of the mobile terminal.

The first sofa armrest 3 is provided with a Wi-Fi chip and a control wire, and the Wi-Fi chip and the control wire are electrically connected to the control motherboard. After the Wi-Fi technology is connected to the terminal for the first time, it will be automatically connected every time the machine is turned on, which is more convenient compared with Bluetooth needs to be connected every time. Just one Wi-Fi chip is needed, which results in a lower cost.

The second sofa armrest 4 is provided with the USB charging port 23. When using the sofa, the USB charging port 23 is convenient for charging the mobile phone or other products. A microphone component is arranged in the second sofa armrest 4, and the microphone arranged at the position of the sofa armrest is configured to recognize the voice. The voice data is collected by the microphone, and the control motherboard adjusts other components according to the voice data.

### Embodiment 2

This embodiment is an extension solution of Embodiment 1.

The first sofa armrest 3 is provided with a first installation slot. A display operation panel is arranged in the first installation slot, and the display operation panel is electrically connected to the control motherboard. In the usual design, the display operation panel adopts a display operation screen, and the first installation slot is set to be rectangular.

The second sofa armrest 4 is provided with a USB interface. The second sofa armrest 4 is provided with a second installation slot, and a wireless charging coil is arranged in the second installation slot. The USB interface and the wireless charging coil are electrically connected to the external power supply through wires and the power plug 20. In the usual design, the second installation slot is set to be rectangular.

### Embodiment 3

Those skilled in the art can understand this embodiment as a more specific illustration of Embodiment 1.

The embodiment provides a multifunctional living room sofa with a health-detection function. The main purpose is to enable the user to complete their health detection work when resting on the sofa. The health detection results can be displayed on the sofa display screen and the mobile phone for easy viewing.

The main components of the sofa of the embodiment are as follows: the sofa seat cushion 1, the sofa backrest 2, the sofa armrests (including the first sofa armrest 3 and the second sofa armrest 4), and the sofa base 5. The body fat detection electrode 8, blood pressure detection device 10, and the detection cuff 22 are arranged inside each of the sofa armrests on both sides. The weight sensor is arranged on the sofa base 5. The ventilation device 13 and the heating device 12 are arranged on the backrest. The blower device and the control motherboard unit are arranged inside the seat cushion. The sound system is arranged on both sides of the sofa backrest. The microphone voice system is arranged on both sides of the sofa armrests. The LED light strip is arranged on the surface of the sofa seat cushion, and the power plug 20, etc.

The ventilation device and the blood pressure detection device are connected to the blower through hoses, and the control motherboard unit controls the inflation and deflation of the gas to complete the main work. Other electrical components are electrically connected to the control motherboard.

Main Functions:

Body fat detection includes body weight, heart rate, body age, fat rate, protein, muscle rate, visceral fat index, basal metabolic rate, water content, bone mass, muscle storage capacity level, and other body functions. These bodily functions are detected by the user when using the sofa and holding the conductive detection handle arranged at the position of the sofa armrest by two hands to collect the body information. The principle of the detection is mostly based on the principle of bioelectrical impedance, that is, when a certain frequency electrical signal passes through the human body, the fat part has a higher “impedance” value than other tissues of the human body. When a safe specific frequency electrical signal passes through the human body, the electrical signal will change to different degrees due to the different “impedance” values of the human body. The human body contains 60%-70% of the water, which is a conductor. When the current is applied to the human body, the muscle is conductive, while the fat is not conductive, and the impedance will be generated. According to the generated impedance, the water content in the human body is calculated, and the fat-free mass is obtained according to the relationship between the water content in the human body and the fat-free mass to obtain the fat mass and the body fat rate. At the same time, the body function parameters, such as heart rate, can be determined by electrical signals and the control motherboard.

Weight detection: The pressure sensor is arranged at the bottom of the sofa base, such that the weight data is measured when the user sits on the sofa, and the above corresponding data is obtained with the use of the conductive handle in cooperation with the detection.

Blood pressure detection: The airbag cuff is arranged in the armrest, and the blood pressure detection function is realized by inflating and deflating the cuff in cooperation with the blood pressure detection module on the motherboard. The blower is arranged in the sofa to provide gas pressure for blood pressure measurement, and the blower and the sofa are connected to each other through hoses. Meanwhile, the blower also provides airflow support for the airbag massage function and ventilation function of the seat.

Massage, ventilation, and heating function: The ventilation function is realized by the blower arranged in the sofa in cooperation with the air outlet and perforated leather arranged at the position of the seat cushion and the backrest. The sofa heating function is realized by the electric heating wire installed at the position of the seat cushion and the backrest for electric heating.

Voice recognition broadcast: When the detection function of the sofa is used, some voice guidance is needed to better detect the body function. For example, during the detection, the voice broadcasts “please put your arms in the designated detection area for 30 seconds,” “please hold the detection handle by two hands for 20 seconds,” and other voice commands. During the detection, it is displayed, in cooperation with the light or sound prompt, that the detection is ongoing and the detection is completed.

Voice control: The microphone arranged at the position of the sofa armrest is configured to recognize the voice. The voice data is collected by the microphone, and the control motherboard adjusts other components according to the voice data.

Light and music entertainment system: The music playback and light adjustment function of the sofa are realized by the LED light strip arranged on the surface of the sofa and the speaker arranged on the sofa backrest in cooperation with the motherboard chip.

Device charging: The surface of the armrest on one side of the sofa is also provided with the USB data line interface, and the USB data line interface is configured to charge the mobile phone or other products during the use of the sofa.

Working Principle:

The equipment needs to be connected before use, and Wi-Fi is connected to the sofa. Age, height, gender, and other basic information are input into the mobile phone. The weight sensor is reset by the motherboard chip to eliminate the weight of the sofa. When the user sits on the sofa, the weight information is obtained. When the detection needs to be carried out, the user puts his or her hands into the corresponding positions of the sofa armrests, the user can control the sofa to start the detection by voice, and the sofa starts the detection step by step according to the sequence set in the device to obtain the body function parameters. In the process, the ventilation, massage, listening to music, and other functions of the sofa can also be turned on.

### Embodiment 4

Those skilled in the art can understand this embodiment as a more specific illustration of Embodiment 1.

The embodiment provides a multifunctional living room sofa with a health-detection function. The main purpose is to enable the user to complete their health-detection work when resting on the sofa. The health detection results can be displayed on the sofa display screen and the mobile phone for easy viewing.

The main components of the sofa of the embodiment are as follows: the sofa seat cushion 1, the sofa backrest 2, the sofa armrests (including the first sofa armrest 3 and the second sofa armrest 4), and the sofa base 5. The body fat detection electrode 8, blood pressure detection device 10, and the detection cuff 22 are arranged inside each of the sofa armrests on both sides. The weight sensor is arranged on the sofa base 5. The ventilation device 13 and the heating device 12 are arranged on the backrest. The blower device and the control motherboard unit are arranged inside the seat cushion. The USB charging port is arranged on the surface of the armrest. The sound system is arranged on both sides of the sofa backrest. The microphone voice system is arranged on both sides of the sofa armrests. The LED light strip arranged on the surface of the sofa seat cushion, and the power plug 20, etc.

Based on the prior software functions, the following effects are achieved:

The ventilation device and the blood pressure detection device are connected to the blower through hoses, and the control motherboard unit controls the inflation and deflation of the gas to complete the main work. Other electrical components are electrically connected to the control motherboard.

Body fat detection includes body weight, heart rate, body age, fat rate, protein, muscle rate, visceral fat index, basal metabolic rate, water content, bone mass, muscle storage capacity level, and other body functions. These bodily functions are detected by the user when using the sofa and holding the conductive detection handle arranged at the position of the sofa armrest by two hands and through the motherboard chip algorithm. The principle of bioelectrical impedance is mostly adopted, that is, when a certain frequency electrical signal passes through the human body, the fat part has a higher “impedance” value than other tissues of the human body. When a safe specific frequency electrical signal passes through the human body, the electrical signal will change to different degrees due to the different “impedance” values of the human body. The human body contains 60-70% of the water, which is a conductor. When the current is applied to the human body, the muscle is conductive, while the fat is not conductive, and the impedance will be generated. According to the generated impedance, the water content in the human body is calculated, and then the fat-free mass is obtained according to the relationship between the water content in the human body and the fat-free mass to calculate the fat mass and the body fat rate. At the same time, the body function parameters, such as heart rate, can be determined by electrical signals in cooperation with an algorithm.

Weight detection: The pressure sensor is arranged at the bottom of the sofa base, such that the weight data is measured when the user sits on the sofa, and the above corresponding data is calculated in cooperation with the conductive handle and the algorithm. The premise is that the user needs to first manually input height, gender, age, and other basic data into the mobile phone.

Blood pressure detection: The airbag cuff is arranged in the armrest, and the blood pressure detection function is realized by inflating and deflating the cuff in cooperation with the blood pressure detection module on the motherboard. The blower is arranged in the sofa to provide gas pressure for blood pressure measurement, and the blower and the sofa are connected to each other through hoses. Meanwhile, the blower also provides airflow support for the airbag massage function and ventilation function of the seat.

Massage, ventilation, and heating function: The ventilation function is realized by the blower arranged in the sofa in cooperation with the air outlet and perforated leather arranged at the position of the seat cushion and the backrest. The sofa heating function is realized by the electric heating wire installed at the position of the seat cushion and the backrest for electric heating.

Voice recognition broadcast: When the detection function of the sofa is used, some voice guidance is needed to better detect the body function. For example, during the detection, the voice broadcasts “please put your arms in the designated detection area for 30 seconds,” “please hold the detection handle by two hands for 20 seconds,” and other voice commands. During the detection, it is displayed, in cooperation with the light or sound prompt, that the detection is ongoing and the detection is completed.

Voice control: The microphone arranged at the position of the sofa armrest is configured to recognize the voice. Here, an activation password or activation button is required. After activation, the detection of the body index is carried out only by the control of the voice. The detection manner can be full item detection or individual item detection.

Light and music entertainment system: The music playback and light adjustment function of the sofa are realized by the LED light strip and the speaker arranged on the surface of the sofa in cooperation with the motherboard chip. The control of these functions can be arranged on the control panel on the surface of the sofa and can also connect to the mobile phone for mobile phone control.

Device charging: The surface of the armrest on one side of the sofa is also provided with the USB data line interface, and the USB data line interface is configured to charge the mobile phone or other products during the use of the sofa.

Working Principle:

The equipment needs to be connected before use, and Wi-Fi is connected to the sofa. Age, height, gender, and other basic information are input into the mobile phone. The weight sensor is reset by the motherboard chip to eliminate the weight of the sofa. When the user sits on the sofa, the weight information is obtained. When the detection needs to be carried out, the user puts his or her hands into the corresponding positions of the sofa armrests, the user can control the sofa to start the detection by voice, and the sofa starts the detection step by step according to the sequence set in the device to obtain the body function parameters. In the process, the ventilation, massage, listening to music, and other functions of the sofa can also be turned on.

According to the present disclosure, the health condition of the human body can be detected while providing rest and massage for users.

In the description of the present disclosure, it should be understood that location or position relationships indicated by the terms “up,” “down,” “front,” “rear,” “left,” “right,” “vertical,” “horizontal,” “top,” “bottom,” “inside,” “outside” are based on the location or position relationships shown in the drawings, only to facilitate the description of the present disclosure and simplify the description, rather than to indicate or imply that the device or element referred to must have a particular orientation and be constructed and operated in a particular orientation, and therefore they should not be construed as a limitation of the present disclosure.

The specific embodiments of the present disclosure are described above. It should be understood that the present disclosure is not limited to the above specific embodiments, and those skilled in the art may make various changes or modifications within the scope of the claims, which does not affect the substance of the present disclosure. In the case of no conflict, the embodiments of the present disclosure as well as the features in embodiments may be arbitrarily combined.

1. A relaxation and healthcare sofa, comprising a sofa seat cushion, wherein the sofa seat cushion is provided with a sofa backrest, a first sofa armrest, a second sofa armrest, a sofa base, and a control motherboard;
each of the first sofa armrest and the second sofa armrest is provided with a first placement slot, and a first massage airbag and a body fat detection electrode are arranged in the first placement slot;
the first sofa armrest is provided with a second placement slot, and a blood pressure detection device and a detection cuff are arranged in the second placement slot, wherein the first placement slot and the second placement slot enclose mutually exclusive spaces;
an inflatable component is arranged in the sofa seat cushion, and the inflatable component is in communication with the first massage airbag to provide airflow support to the first massage airbag and said inflatable component is in communication with the detection cuff via at least one hose to provide gas pressure for blood pressure measurement;
the sofa base is provided with a pressure sensor; and
the body fat detection electrode, the inflatable component, and the pressure sensor are electrically connected to the control motherboard.

2. The relaxation and healthcare sofa according to claim 1, wherein the sofa backrest is arranged on a side wall of the sofa seat cushion;
the first sofa armrest and the second sofa armrest are located on both sides of the sofa seat cushion, respectively; and
the sofa base is arranged on a bottom side wall of the sofa seat cushion.

3. The relaxation and healthcare sofa according to claim 1, wherein a heating device is arranged on the sofa backrest, and the heating device is electrically connected to the control motherboard.

4. The relaxation and healthcare sofa according to claim 1, wherein a ventilation device is arranged on the sofa backrest, and the ventilation device is electrically connected to the control motherboard.

5. The relaxation and healthcare sofa according to claim 1, wherein a speaker component is arranged on the sofa backrest, and the speaker component is electrically connected to the control motherboard; and
the speaker component is arranged at positions corresponding to a user's ears on the sofa backrest.

6. The relaxation and healthcare sofa according to claim 1, wherein each of a peripheral edge of the first sofa armrest and a peripheral edge of the second sofa armrest is provided with a light emitting diode (LED) light strip component, and the LED light strip component is electrically connected to the control motherboard.

7. The relaxation and healthcare sofa according to claim 1, wherein each of a side wall of the first sofa armrest and a side wall of the second sofa armrest is provided with a storage bag for placing items.

8. The relaxation and healthcare sofa according to claim 1, wherein a cover pad is arranged at an opening of the second placement slot, and the cover pad is detachably arranged on the first sofa armrest.

9. The relaxation and healthcare sofa according to claim 1, wherein a massage component is arranged on the sofa seat cushion and the sofa backrest.

10. The relaxation and healthcare sofa according to claim 1, wherein the sofa base is configured as a rectangular support base; and the pressure sensor is entirely arranged below the rectangular support base.

11. The relaxation and healthcare sofa according to claim 1, wherein the sofa base is provided with a lifting component, and the lifting component is electrically connected to the control motherboard; and the lifting component is configured to raise or lower the sofa seat cushion.

12. (canceled)

13. The relaxation and healthcare sofa according to claim 1, wherein health parameters detected by the body fat detection electrode comprise: muscle storage capacity level, protein, basal metabolic rate, water content, body weight, fat rate, body mass index (HMI), muscle mass, bone mass, body age, visceral fat index, and resting heart rate; and
a health parameter detected by the blood pressure detection device comprises: blood pressure.

14. The relaxation and healthcare sofa according to claim 1, wherein a support clamping component is arranged on the first sofa armrest, and the support clamping component is configured to clamp a mobile phone or a tablet.

15. The relaxation and healthcare sofa according to claim 1, wherein the second sofa armrest is provided with a universal serial bus (USB) charging port.

16. (canceled)
